(19) United States
(12) Patent Application Publication
(10) Pub. No.: US 2025/0390132 A1
(43) Pub. Date: Dec. 25, 2025

(54) BANDGAP VOLTAGE REFERENCE CIRCUIT AND VOLTAGE COMPARISON SYSTEM

(71) Applicant: Realtek Semiconductor Corporation, Hsinchu (TW)

(72) Inventors: Tsung-Yen TSAI, Hsinchu (TW); Yan-Yu CHEN, Hsinchu (TW)

(21) Appl. No.: 19/172,679

(22) Filed: Apr. 8, 2025

(30) Foreign Application Priority Data
Jun. 20, 2024 (TW) 113122811

(51) Int. Cl. G05F 3/22; G05F 1/46

(52) U.S. Cl. CPC G05F 3/22; G05F 1/468

(57) ABSTRACT

A bandgap voltage reference circuit comprises a current mirror circuit, a first sub-circuit and an output circuit. The current mirror circuit is coupled between an input source and a ground, is configured to generate a first current, and comprises first and second bipolar junction transistors (BJTs) and a first resistor. The two BJTs' bases are coupled together. The first resistor is coupled between the first BJT's emitter and the ground. The first sub-circuit comprises a transistor coupled to the first BJT's base and collector, comprises a second resistor coupled between the transistor and the ground, and is configured to generate a second current based on the second resistor and a base-emitter potential difference of the second BJT. The output circuit is coupled between the input source and the ground, and is configured to generate an output reference voltage based on the first, second currents and a third resistor.

### RELATED APPLICATIONS

This application claims priority to Taiwan Application Serial Number 113122811, filed on Jun. 20, 2024, which is herein incorporated by reference in its entirety.

### BACKGROUND

### Technical Field

The present disclosure relates to generating reference voltage based on input source. More particularly, the present disclosure relates to a bandgap voltage reference circuit and a voltage comparison system that is not affected by circuit temperature and has improved power supply rejection ratio.

### Description of Related Art

The bandgap voltage reference circuit is a voltage reference circuit widely used in integrated circuits. With appropriate circuit design, the bandgap voltage reference circuit can provide a stable reference voltage for integrated circuits that is not affected by circuit temperature.

However, in the design of today's bandgap voltage reference circuit, the series connection of multiple resistors inside the circuit may result in a large voltage drop, causing the bandgap voltage reference circuit to be unable to support lower input voltages, thereby reducing the applicable input range. In addition, in order to solve the aforementioned problem, operational amplifiers may be added into the bandgap voltage reference circuit in some instances, but this also increases the area and complexity of the circuit. Therefore, how to make the bandgap voltage reference circuit support lower input voltage and wider input range without significantly increasing the circuit complexity is one of the topics in this field.

### SUMMARY

A bandgap voltage reference circuit is provided in the present disclosure. The bandgap voltage reference circuit comprises a current mirror circuit, a first sub-circuit and an output circuit. The current mirror circuit is coupled between an input source and a ground source, and is configured to generate a first current. The current mirror circuit comprises a first bipolar junction transistor, a second bipolar junction transistor and a first resistor. Each of the first bipolar junction transistor and the second bipolar junction transistor has a base terminal, an emitter terminal and a collector terminal, wherein the base terminal of the first bipolar junction transistor is coupled to the base terminal of the second bipolar junction transistor. The first resistor is coupled between the emitter terminal of the first bipolar junction transistor and the ground source. The first sub-circuit is coupled to the current mirror circuit and the ground source, and comprises a first N-type transistor and a second resistor. The first N-type transistor is coupled to the base terminal and the collector terminal of the first bipolar junction transistor. The second resistor is coupled between the first N-type transistor and the ground source. The first sub-circuit is configured to generate a second current based on the second resistor and a base-emitter potential difference of the second bipolar junction transistor. The output circuit is coupled between the input source and the ground source, and comprises a third resistor. The output circuit is configured to generate an output reference voltage based on the first current, the second current and the third resistor.

A voltage comparison system is provided in the present disclosure. The voltage comparison system comprises a bandgap voltage reference circuit and a comparison circuit. The bandgap voltage reference circuit comprises a current mirror circuit, a first sub-circuit and an output circuit. The current mirror circuit is coupled between an input source and a ground source, and is configured to generate a first current. The current mirror circuit comprises a first bipolar junction transistor, a second bipolar junction transistor and a first resistor. Each of the first bipolar junction transistor and the second bipolar junction transistor has a base terminal, an emitter terminal and a collector terminal, wherein the base terminal of the first bipolar junction transistor is coupled to the base terminal of the second bipolar junction transistor. The first resistor is coupled between the emitter terminal of the first bipolar junction transistor and the ground source. The first sub-circuit is coupled to the current mirror circuit and the ground source, and comprises a first N-type transistor and a second resistor. The first N-type transistor is coupled to the base terminal and the collector terminal of the first bipolar junction transistor. The second resistor is coupled between the first N-type transistor and the ground source. The first sub-circuit is configured to generate a second current based on the second resistor and a base-emitter potential difference of the second bipolar junction transistor. The output circuit is coupled between the input source and the ground source, and comprises a third resistor. The output circuit is configured to generate an output reference voltage based on the first current, the second current and the third resistor. The comparison circuit is coupled to the bandgap voltage reference circuit, and is configured to generate a caparison result based on a comparison voltage and the output reference voltage.

With the bandgap voltage reference circuit and the voltage comparison system in the present disclosure, it can support lower input source and provide better power supply rejection ratio (PSRR) without significantly increasing the circuit complexity.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows.

FIG. 1 is a functional block diagram of a bandgap voltage reference circuit in accordance with some embodiments of the present disclosure.

FIG. 2 is a circuit diagram of a bandgap voltage reference circuit in accordance with some embodiments of the present disclosure.

FIG. 3 is a circuit diagram of a bandgap voltage reference circuit in accordance with some embodiments of the present disclosure.

FIG. 4 is a circuit diagram of a bandgap voltage reference circuit in accordance with some embodiments of the present disclosure.

FIG. 5 is a circuit diagram of a voltage comparison system in accordance with some embodiments of the present disclosure.

FIG. 6 is a schematic diagram of cascaded bandgap voltage reference circuits in accordance with some embodiments of the present disclosure.

FIG. 7 is a schematic diagram of the relationship between frequency and power supply rejection ratio (PSRR) of a bandgap voltage reference circuit in accordance with some embodiments of the present disclosure.

### DETAILED DESCRIPTION

Reference will now be made in detail to the present embodiments of the disclosure, examples of which are illustrated in the accompanying drawings.

In the present disclosure, when an element is referred to as “connected”, it may mean “electrically connected”. When an element is referred to as “coupled”, it may mean “electrically coupled”. “Connected” or “coupled” can also be used to indicate that two or more components operate or interact with each other. As used in the present disclosure, the singular forms “a”, “one” and “the” are also intended to include plural forms, unless the context clearly indicates otherwise. It will be further understood that when used in this specification, the terms “comprises (comprising)” and/or “includes (including)” designate the existence of stated features, steps, operations, elements and/or components, but the existence or addition of one or more other features, steps, operations, elements, components, and/or groups thereof are not excluded.

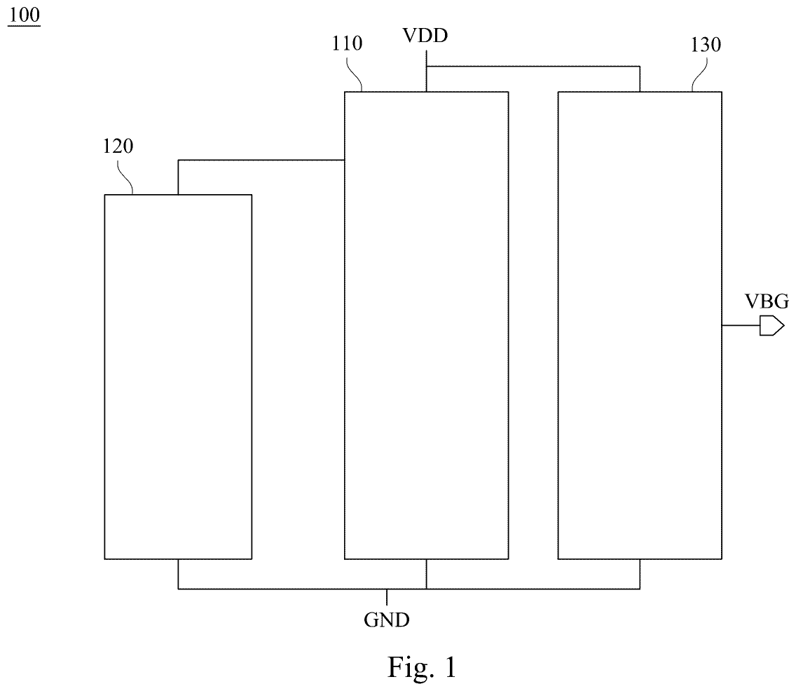

FIG. 1 is a functional block diagram of a bandgap voltage reference circuit 100 in accordance with some embodiments of the present disclosure. In some embodiments, the bandgap voltage reference circuit 100 comprises a current mirror circuit 110, a sub-circuit 120 and an output circuit 130.

The current mirror circuit 110 is coupled between an input source VDD and a ground source GND, and is configured to generate a current I_R1. The sub-circuit 120 is coupled to the current mirror circuit 110 and the ground source GND, and is configured to generate a current I_R2. The output circuit 130 is coupled between the input source VDD and the ground source GND, and is configured to generate a current I_BG and an output reference voltage VBG.

In some embodiments, the current I_R1 is a current positively related to a circuit temperature (i.e., Current Proportional to Absolute Temperature, IPTAT), and the current I_R2 is a current negatively related to the circuit temperature (i.e., Current Complementary to Absolute Temperature, ICTAT). Therefore, by adding the current I_R1 and the current I_R2 through the current mirror circuit 110 and replicating them to the output circuit 130, the current I_BG that is approximately independent of the temperature can be obtained, thereby allowing the output circuit 130 to output the output reference voltage VBG that is approximately independent of the temperature.

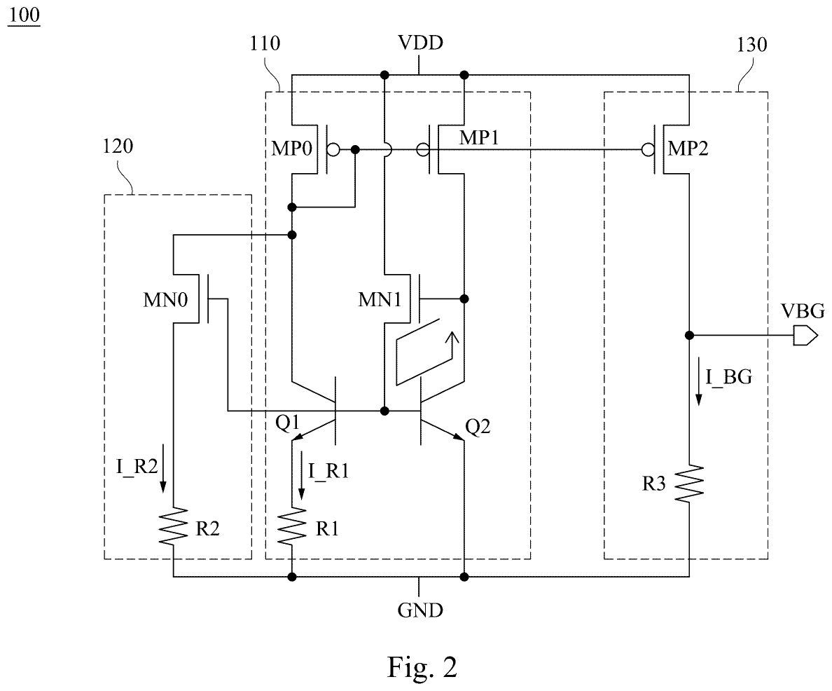

Regarding the circuit structure of the bandgap voltage reference circuit 100, please further refer to FIG. 2. FIG. 2 is a circuit diagram of the bandgap voltage reference circuit 100 in accordance with some embodiments of the present disclosure.

In some embodiments, the current mirror circuit 110 comprises P-type transistors MP0, MP1, an N-type transistor MN1, bipolar junction transistors (BJTs) Q1, Q2 and a resistor R1.

The source terminals of the P-type transistors MP0 and MP1 are coupled to the input source VDD, the gate terminals of the P-type transistors MP0 and MP1 are coupled to each other, the drain terminals of the P-type transistors MP0 and MP1 are respectively coupled to the collector terminals of the BJTs Q1 and Q2, and the gate terminal of the P-type transistors MP0 is coupled to its drain terminal.

The drain terminal of the N-type transistor MN1 is coupled to the input source VDD, the gate terminal of the N-type transistor MN1 is coupled to the drain terminal of the P-type transistor MP1 (i.e., the collector terminal of the BJT Q2), and the source terminal of the N-type transistor MN1 is coupled to the base terminals of the BJTs Q1 and Q2.

In some embodiments, the N-type transistor MN1 can be implemented with a native N-type transistor. In other words, the potential difference between the gate terminal and source terminal of the N-type transistor MN1 can be approximately zero. Therefore, the N-type transistor MN1 can be configured to provide a base terminal current for the BJTs Q1 and Q2, and provide a negative feedback path (indicated by a counterclockwise arrow) to lock a voltage between the N-type transistor MN1 and the BJT Q2.

The collector terminals of the BJTs Q1 and Q2 are respectively coupled to the drain terminals of the P-type transistors MP0 and MP1, the base terminals of the BJTs Q1 and Q2 are coupled to each other, the emitter terminal of the BJT Q1 is coupled to the resistor R1, and the emitter terminal of the BJT Q2 is coupled to the ground source GND. The resistor R1 is coupled between the emitter terminal of the BJT Q1 and the ground source GND.

Consequently, in the current mirror circuit 110, the difference between the base-emitter potential difference of the BJT Q1 and the base-emitter potential difference of the BJT Q2 can be stored on the resistor R1, thereby generating the current I_R1. Moreover, since BJTs have the characteristic that the base-emitter potential difference is negatively related to the circuit temperature, the difference between the base-emitter potential difference of the BJT Q1 and the base-emitter potential difference of the BJT Q2 will be positively related to the circuit temperature, and thus the current I_R1 will be positively related to the circuit temperature (i.e., IPTAT).

In some embodiments, the sub-circuit 120 comprises an N-type transistor MN0 and a resistor R2. The drain terminal of the N-type transistor MN0 is coupled to the drain terminal of the P-type transistor MP0 (i.e., the collector terminal of the BJT Q1), the gate terminal of the N-type transistor MN0 is coupled to the base terminals of the BJTs Q1 and Q2, and the source terminal of the N-type transistor MN0 is coupled to the resistor R2. The resistor R2 is coupled between the source terminal of the N-type transistor MN0 and the ground source GND.

In some embodiments, the N-type transistor MN0 can also be implemented with a native N-type transistor. Consequently, the voltage at the source terminal of the N-type transistor MN0 at this time may be equal to the base-emitter potential difference of the BJT Q2. As mentioned above, since BJTs have the characteristic that the base-emitter potential difference is negatively related to the circuit temperature, the voltage at the source terminal of the N-type transistor MN0 will also be negatively related to the circuit temperature, and thus the current I_R2 generated by the sub-circuit 120 will also be negatively related to the circuit temperature (i.e., ICTAT).

In some embodiments, the output circuit 130 comprises a P-type transistor MP2 and a resistor R3. The source terminal of the P-type transistor MP2 is coupled to the input source VDD, the gate terminal of the P-type transistor MP2 is coupled to the gate terminals of the P-type transistors MP0 and MP1, and the drain terminal of the P-type transistor MP2 is coupled to the resistor R3 for transmitting the output reference voltage VBG. The resistor R3 is coupled between the drain terminal of the P-type transistor MP2 and the ground source GND. With the circuit design of the P-type transistor MP2, the current I_R1 and the current I_R2 are replicated to the output circuit 130 to generate the current I_BG. Since the current I_R1 and the current I_R2 are positively and negatively related to the circuit temperature respectively, the current I_BG is approximately independent of the circuit temperature, and thus the output reference voltage VBG is also approximately independent of the circuit temperature, achieving the function of outputting a stable voltage.

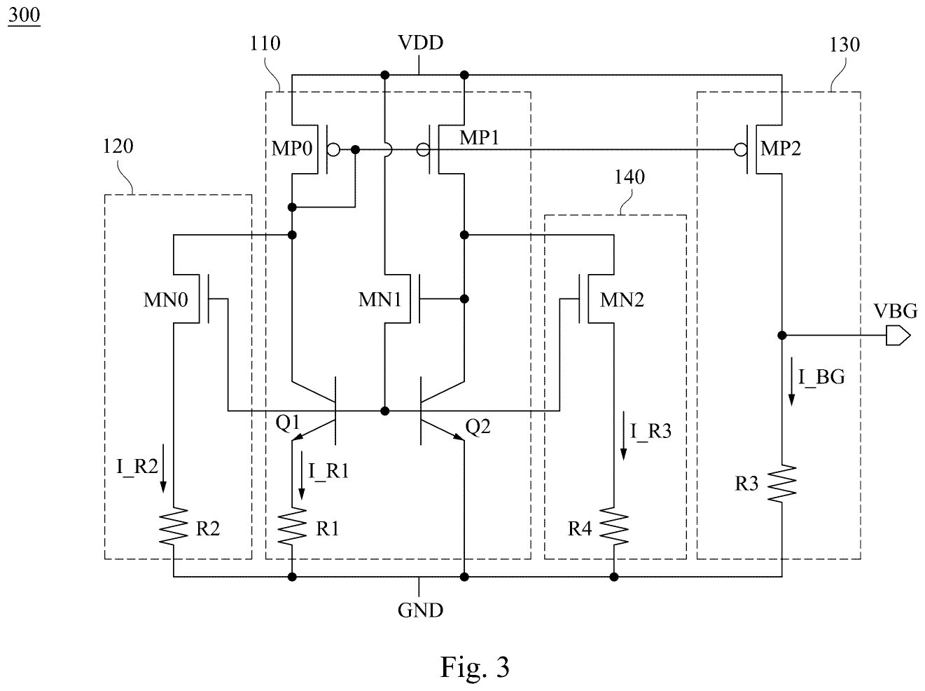

FIG. 3 is a circuit diagram of a bandgap voltage reference circuit 300 in accordance with some embodiments of the present disclosure. The bandgap voltage reference circuit 300 is similar to the bandgap voltage reference circuit 200 in FIG. 2. The difference is that the bandgap voltage reference circuit 300 further comprises a sub-circuit 140.

The sub-circuit 140 is coupled to the current mirror circuit 110 and the ground source GND, and is configured to generate a current I_R3. In some embodiments, the sub-circuit 140 comprises an N-type transistor MN2 and a resistor R4. The drain terminal of the N-type transistor MN2 is coupled to the drain terminal of the P-type transistor MP1 (i.e., the collector terminal of the BJT Q2), the gate terminal of the N-type transistor MN2 is coupled to the base terminals of the BJTs Q1 and Q2, and the source terminal of the N-type transistor MN2 is coupled to the resistor R4. The resistor R4 is coupled between the source terminal of the N-type transistor MN2 and the ground source GND. In some embodiments, the resistance of the resistor R4 is equal to the resistance of the resistor R2.

In some embodiments, the N-type transistor MN2 can also be implemented with a native N-type transistor. Consequently, the voltage at the source terminal of the N-type transistor MN2 at this time may be equal to the base-emitter potential difference of the BJT Q2. In other words, similar to the sub-circuit 120, the current I_R3 generated by the sub-circuit 140 will also be negatively related to the circuit temperature (i.e., ICTAT).

In the embodiment of FIG. 3, the currents I_R1, I_R2 and I_R3 are replicated to the output circuit 130 to generate the current I_BG approximately independent of the circuit temperature, thereby allowing the output circuit 130 to output the output reference voltage VBG approximately independent of the circuit temperature and achieving the function of outputting a stable voltage.

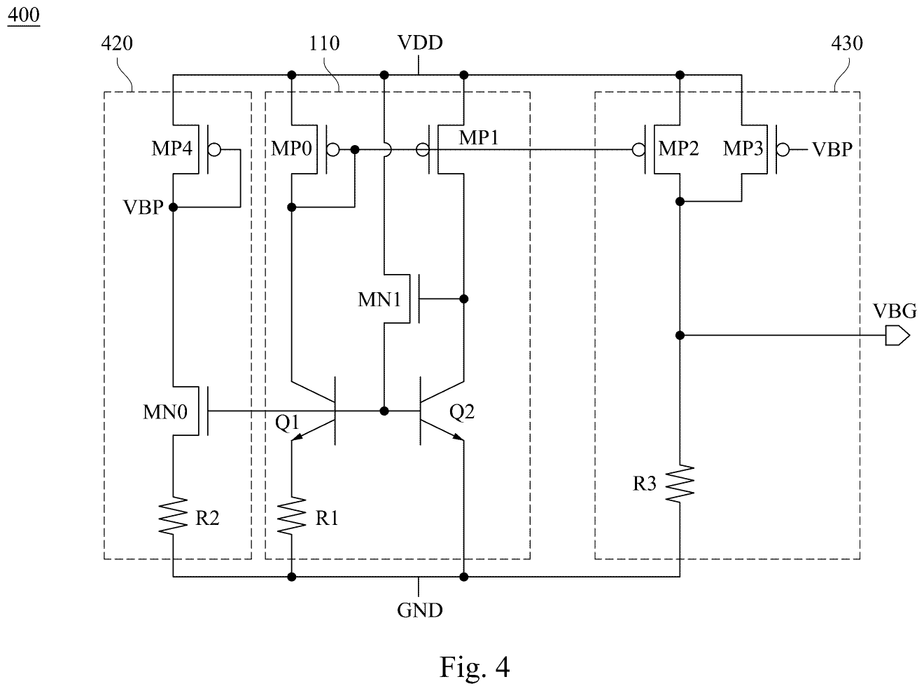

FIG. 4 is a circuit diagram of a bandgap voltage reference circuit 400 in accordance with some embodiments of the present disclosure. In some embodiments, the bandgap voltage reference circuit 400 comprises the current mirror circuit 110, a sub-circuit 420 and an output circuit 430.

The sub-circuit 420 is similar to the sub-circuit 120 of FIG. 2. The difference is that the sub-circuit 420 further comprises a P-type transistor MP4. The source terminal of the P-type transistor MP4 is coupled to the input source VDD, the gate terminal of the P-type transistor MP4 is coupled to its drain terminal, and the drain terminal of the P-type transistor MP4 is coupled to the drain terminal of the N-type transistor MN0. With the P-type transistor MP4, a self-bias node VBP can be formed at the drain terminal of the P-type transistor MP4.

The output circuit 430 is similar to the output circuit 130 of FIG. 2. The difference is that the output circuit 430 further comprises a P-type transistor MP3. The source terminal of the P-type transistor MP3 is coupled to the input source VDD, the gate terminal of the P-type transistor MP3 is coupled to the self-bias node VBP, and the drain terminal of the P-type transistor MP3 is coupled to the drain terminal of the P-type transistor MP2. With the circuit design of the P-type transistors MP2 and MP3, the currents output by the current mirror circuit 110 and the sub-circuit 420 are replicated to the output circuit 430 to generate the output reference voltage VBG approximately independent of the circuit temperature, thereby achieving the function of outputting a stable voltage.

It should be noted that although the N-type transistors MN0, MN1 and MN2 in the present disclosure are described as being implemented with native N-type transistors, the present disclosure is not limited to this. The N-type transistors MN0, MN1 and MN2 implemented with other types of transistors are within the scope of the present disclosure. In some embodiments, the N-type transistors MN0, MN1 and MN2 can be implemented with general N-type transistors.

With the aforementioned bandgap voltage reference circuits 100, 300 and 400, the output of a reference voltage that is approximately independent of the circuit temperature can be achieved. In addition, since native N-type transistors are applied in the bandgap voltage reference circuits 100, 300 and 400, they can operate at lower power source. On the other hand, since each of the sub-circuits 120, 140 and 420 comprises only one transistor and one resistor, compared with traditional configurations of operational amplifiers, the bandgap voltage reference circuits 100, 300 and 400 can have simpler circuits and smaller areas.

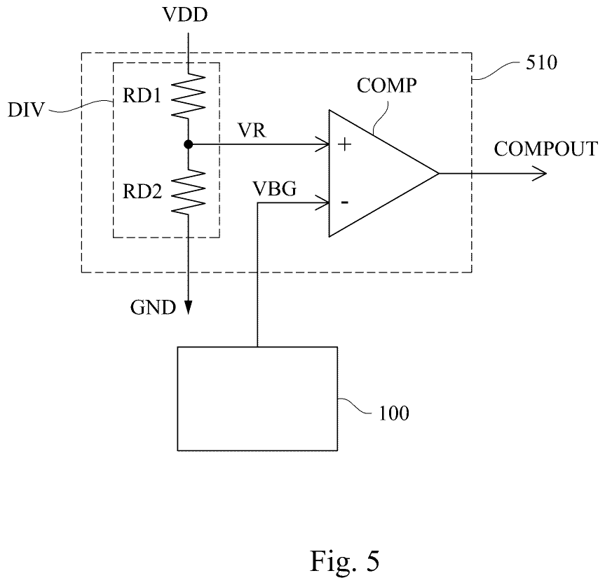

FIG. 5 is a circuit diagram of a voltage comparison system 500 in accordance with some embodiments of the present disclosure. In some embodiments, the voltage comparison system 500 comprises a comparison circuit 510 and the bandgap voltage reference circuit 100, and is configured to perform power on reset (POR) and brown out detection (BOD) functions of a device (e.g., a chip on which the voltage comparison system 500 is located). In some embodiments, the bandgap voltage reference circuit 100 in FIG. 5 can be replaced by the bandgap voltage reference circuit 300 or the bandgap voltage reference circuit 400.

In some embodiments, the comparison circuit 510 comprises a voltage divider circuit DIV and a comparator COMP. The voltage divider circuit DIV is coupled between the input source VDD and the ground source GND, and is configured to output a comparison voltage VR to the comparator COMP according to the ratio of the resistance of its voltage divider resistors RD1 and RD2. The comparator COMP is coupled to the bandgap voltage reference circuit 100, and is configured to receive the comparison voltage VR and the output reference voltage VBG for generating a comparison result COMPOUT, so as to detect the power-on and brown-out of the system.

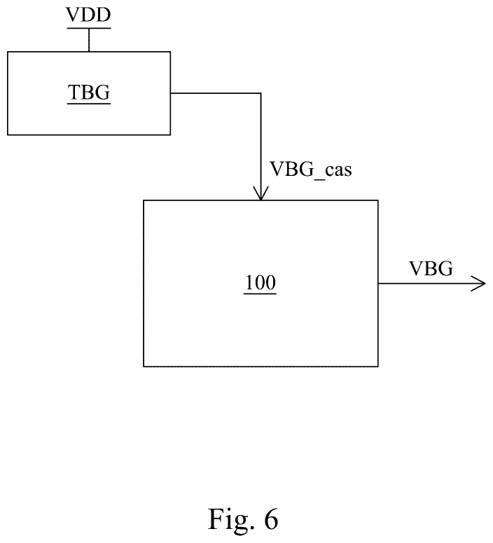

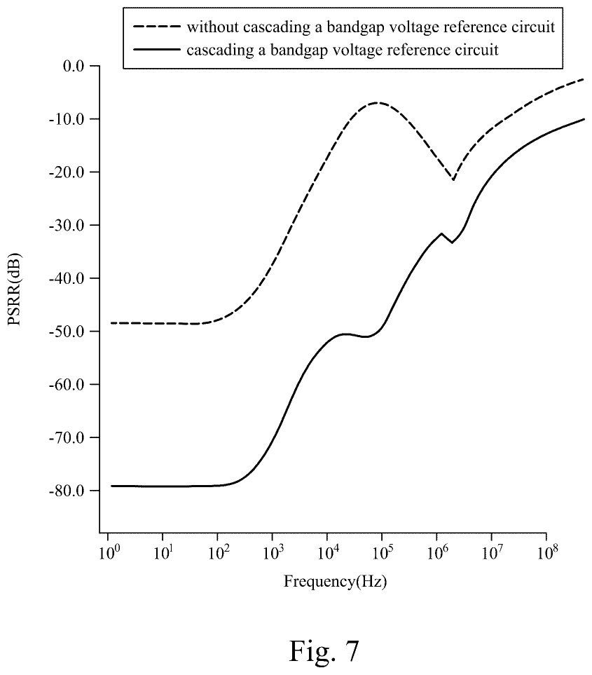

Since the bandgap voltage reference circuits 100, 300 and 400 in the present disclosure have the characteristic of being able to operate at a lower input source, they can also be used to assist traditional bandgap voltage reference circuits to obtain a better power supply rejection ratio (PSRR). Please refer to FIG. 6 and FIG. 7. FIG. 6 is a schematic diagram of cascaded bandgap voltage reference circuits in accordance with some embodiments of the present disclosure.

In the embodiment of FIG. 6, a bandgap voltage reference circuit TBG (e.g., a traditional bandgap voltage reference circuit with higher PSRR) is coupled to the input source VDD and the bandgap voltage reference circuit 100, and generates an output reference voltage VBG_cas to the bandgap voltage reference circuit 100 based on the input source VDD. Next, the bandgap voltage reference circuit 100 takes the output reference voltage VBG_cas as the input source to further generate the output reference voltage VBG. With the aforementioned cascade method, when the input source VDD is disturbed, it can be suppressed twice, and thus the output reference voltage VBG has a better PSRR.

It should be noted that in some embodiments, the bandgap voltage reference circuit 100 in FIG. 6 also can be replaced by the bandgap voltage reference circuit 300 or the bandgap voltage reference circuit 400.

FIG. 7 is a schematic diagram of the relationship between frequency and power supply rejection ratio (PSRR) of a bandgap voltage reference circuit in accordance with some embodiments of the present disclosure. In FIG. 7, the horizontal axis is the frequency of the disturbance of the input source VDD, and the vertical axis is the PSRR of the bandgap voltage reference circuit. Under the same disturbance frequency, when PSRR is lower, it means that the bandgap voltage reference circuit is better at suppressing disturbances. It can be seen from FIG. 7 that when the bandgap voltage reference circuit TBG is cascaded with the bandgap voltage reference circuit 100, the PSRR at the same disturbance frequency decreases significantly, thereby achieving a better disturbance suppression.

With the bandgap voltage reference circuits 100, 300, 400 and the voltage comparison system 500 in the present disclosure, they can not only support lower and wider input source, but also assist in detecting the power-on and brown-out of chip systems and assist other bandgap voltage reference circuits to obtain better PSRR, without significantly increasing the circuit complexity.

The above are preferred embodiments of the present disclosure. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A bandgap voltage reference circuit, comprising:
a current mirror circuit, coupled between an input source and a ground source, and configured to generate a first current, wherein the current mirror circuit comprises:
a first bipolar junction transistor, comprising a base terminal, an emitter terminal and a collector terminal;
a second bipolar junction transistor, comprising a base terminal, an emitter terminal and a collector terminal, wherein the base terminal of the first bipolar junction transistor is coupled to the base terminal of the second bipolar junction transistor; and
a first resistor, coupled between the emitter terminal of the first bipolar junction transistor and the ground source;
a first sub-circuit, coupled to the current mirror circuit and the ground source, wherein the first sub-circuit comprises:
a first N-type transistor, coupled to the base terminal and the collector terminal of the first bipolar junction transistor; and
a second resistor, coupled between the first N-type transistor and the ground source, wherein the first sub-circuit is configured to generate a second current based on the second resistor and a base-emitter potential difference of the second bipolar junction transistor; and
an output circuit, coupled between the input source and the ground source, and comprising a third resistor, wherein the output circuit is configured to generate an output reference voltage based on the first current, the second current and the third resistor.

2. The bandgap voltage reference circuit of claim 1, wherein the current mirror circuit further comprises:
two first P-type transistors, coupled to the input source, and respectively coupled to the collector terminal of the first bipolar junction transistor and the collector terminal of the second bipolar junction transistor; and
a second N-type transistor, coupled to the input source, coupled to the base terminal and the collector terminal of the second bipolar junction transistor, and configured to lock a voltage at the base terminal of the second bipolar junction transistor.

3. The bandgap voltage reference circuit of claim 2, wherein the output circuit further comprises a second P-type transistor coupled between the input source and the third resistor and configured to replicate the first current and the second current to the output circuit.

4. The bandgap voltage reference circuit of claim 3, wherein the output circuit further comprises a third P-type transistor coupled between the input source and the third resistor in parallel with the second P-type transistor, and
wherein the first sub-circuit further comprises a fourth P-type transistor coupled between the input source and the first N-type transistor.

5. The bandgap voltage reference circuit of claim 2, further comprising a second sub-circuit coupled to the current mirror circuit and the ground source, wherein the second sub-circuit comprises:
a third N-type transistor, coupled to the base terminal and the collector terminal of the second bipolar junction transistor; and
a fourth resistor, coupled between the second N-type transistor and the ground source.

6. The bandgap voltage reference circuit of claim 5, wherein each of the first N-type transistor, the second N-type transistor and the third N-type transistor is a native N-type transistor.

7. The bandgap voltage reference circuit of claim 5, wherein a resistance of the second resistor is equal to a resistance of the fourth resistor.

8. The bandgap voltage reference circuit of claim 1, wherein the first current is positively related to a circuit temperature, and the second current is negatively related to the circuit temperature.

9. A voltage comparison system, comprising:
a bandgap voltage reference circuit, comprising:
a current mirror circuit, coupled between an input source and a ground source, and configured to generate a first current, wherein the current mirror circuit comprises:
a first bipolar junction transistor, comprising a base terminal, an emitter terminal and a collector terminal;
a second bipolar junction transistor, comprising a base terminal, an emitter terminal and a collector terminal, wherein the base terminal of the first bipolar junction transistor is coupled to the base terminal of the second bipolar junction transistor; and
a first resistor, coupled between the emitter terminal of the first bipolar junction transistor and the ground source;
a first sub-circuit, coupled to the current mirror circuit and the ground source, wherein the first sub-circuit comprises:
a first N-type transistor, coupled to the base terminal and the collector terminal of the first bipolar junction transistor; and
a second resistor, coupled between the first N-type transistor and the ground source, wherein the first sub-circuit is configured to generate a second current based on the second resistor and a base-emitter potential difference of the second bipolar junction transistor; and
an output circuit, coupled between the input source and the ground source, and comprising a third resistor, wherein the output circuit is configured to generate an output reference voltage based on the first current, the second current and the third resistor; and
a comparison circuit, coupled to the bandgap voltage reference circuit, and configured to generate a caparison result based on a comparison voltage and the output reference voltage.

10. The voltage comparison system of claim 9, wherein the current mirror circuit further comprises:
two first P-type transistors, coupled to the input source, and respectively coupled to the collector terminal of the first bipolar junction transistor and the collector terminal of the second bipolar junction transistor; and
a second N-type transistor, coupled to the input source, coupled to the base terminal and the collector terminal of the second bipolar junction transistor, and configured to lock a voltage at the base terminal of the second bipolar junction transistor.

11. The voltage comparison system of claim 10, wherein the output circuit further comprises a second P-type transistor coupled between the input source and the third resistor and configured to replicate the first current and the second current to the output circuit.

12. The voltage comparison system of claim 11, wherein the output circuit further comprises a third P-type transistor coupled between the input source and the third resistor in parallel with the second P-type transistor, and
wherein the first sub-circuit further comprises a fourth P-type transistor coupled between the input source and the first N-type transistor.

13. The voltage comparison system of claim 10, wherein the bandgap voltage reference circuit further comprises a second sub-circuit coupled to the current mirror circuit and the ground source, wherein the second sub-circuit comprises:
a third N-type transistor, coupled to the base terminal and the collector terminal of the second bipolar junction transistor; and
a fourth resistor, coupled between the second N-type transistor and the ground source.

14. The voltage comparison system of claim 13, wherein each of the first N-type transistor, the second N-type transistor and the third N-type transistor is a native N-type transistor.

15. The voltage comparison system of claim 13, wherein a resistance of the second resistor is equal to a resistance of the fourth resistor.

16. The voltage comparison system of claim 9, wherein the first current is positively related to a circuit temperature, and the second current is negatively related to the circuit temperature.

17. The voltage comparison system of claim 9, wherein the comparison circuit comprises a voltage divider circuit coupled between the input source and the ground source and configured to generate the comparison voltage based on the input source and the ground source.
